(19) United States
(12) Patent Application Publication
(10) Pub. No.: US 2016/0012072 A1
(43) Pub. Date: Jan. 14, 2016

(54) PUBLISHING CONTENT PENDING FINAL APPROVAL

(71) Applicant: International Business Machines Corporation, Armonk, NY (US)

(72) Inventors: Nicholas A. Baldwin, Gladesville (AU); Mark C. Hampton, Fitzroy North (AU); Stefan A. Hepper, Morgan Hill, CA (US); Eric M. de Morentin, Manly (AU)

(21) Appl. No.: 14/639,519

(22) Filed: Mar. 5, 2015

Related U.S. Application Data
(63) Continuation of application No. 14/327,949, filed on Jul. 10, 2014.

(51) Int. Cl. G06F 17/30; H04L 29/08

(52) U.S. Cl. CPC G06F 17/3089; H04L 67/1095

(57) ABSTRACT

According to embodiments of the present invention, a content generation event associated with content having a status is received by one or more computer processors. In response to the content generation event satisfying a predetermined criterion, the content is published by one or more computer processors with a pending approval status that is associated with an approval step. In response to satisfaction of the approval step, the pending approval status of the content to an approved status is changed by one or more computer processors.

### BACKGROUND

The present disclosure relates generally to the field of content management, and more particularly to publishing content pending final approval.

Generally, a content management system (CMS) is an application that stores and organizes Web content, as well as information about how the content can be used and presented. The typical CMS workflow controls the access to content, its verification, and eventual approval. A typical workflow, as reflected in FIG. 1, may comprise one or more stages that include content generation (initial draft by User A), approval by User B, and subsequent publication.

### SUMMARY

According to embodiments of the present invention, a content generation event associated with content having a status is received by one or more computer processors. In response to the content generation event satisfying a predetermined criterion, the content is published by one or more computer processors with a pending approval status that is associated with an approval step. In response to satisfaction of the approval step, the pending approval status of the content to an approved status is changed by one or more computer processors.

### BRIEF DESCRIPTION OF THE SEVERAL VIEWS OF THE DRAWINGS

FIG. 1 depicts a typical content management system workflow.

FIG. 2 is a block diagram illustrating an environment, in accordance with an embodiment of the present invention.

FIG. 3 illustrates an embodiment of the present invention wherein content is generated and approved, in accordance with an embodiment of the present invention.

FIG. 4 illustrates operational steps of a program function, in accordance with an embodiment of the present invention.

FIG. 5 depicts a block diagram of components of the server executing the program function, in accordance with an embodiment of the present invention.

### DETAILED DESCRIPTION

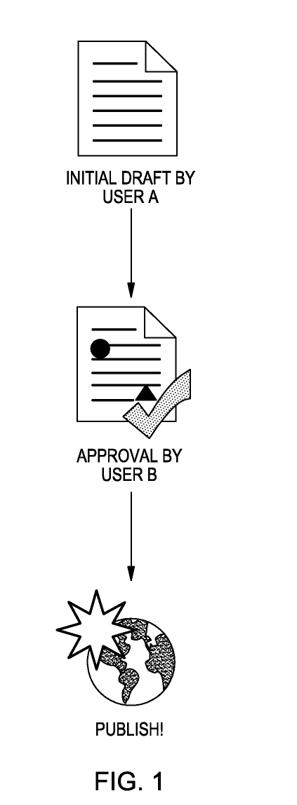

With reference now to FIGS. 1-5, the descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

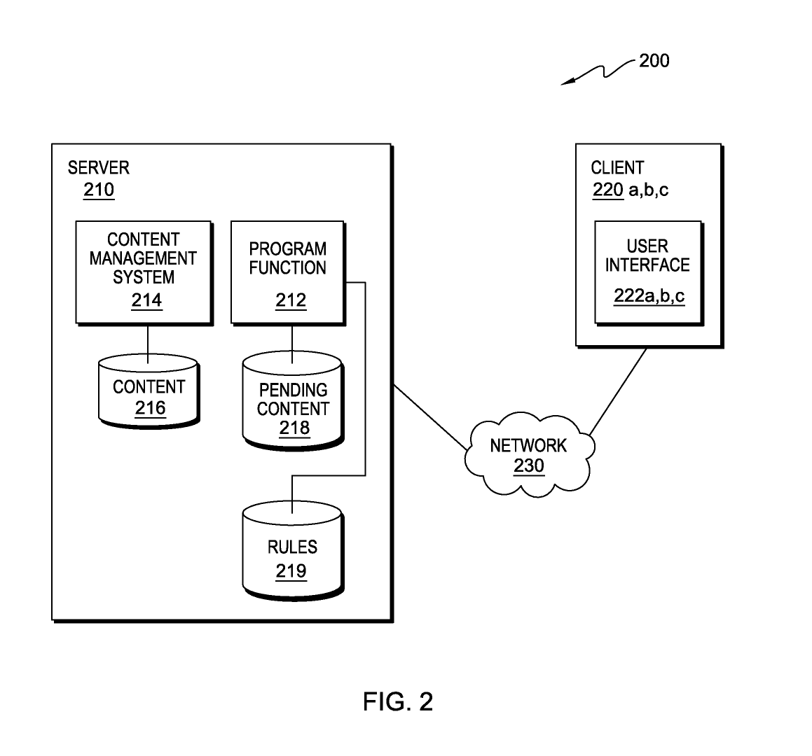

Embodiments of the present invention will now be described in detail with reference to the Figures. FIG. 2 is a block diagram illustrating an environment, generally designated 200, in accordance with one embodiment of the present invention.

Environment 200 includes server 210 and clients 220a,b,c, all interconnected over network 230. Network 230 can be, for example, a local area network (LAN), a wide area network (WAN) such as the Internet, or a combination of the two, and can include wired, wireless, or fiber optic connections. Network 230 may be a distributed computing environment utilizing clustered computers and components that act as a single pool of seamless resources, as is common in data centers and with cloud computing applications or “clouds”. In general, network 230 can be any combination of connections and protocols that will support communications between server 210 and clients 220a,b,c.

In various embodiments of the present invention, server 210 and clients 220a,b,c may be a laptop computer, a tablet computer, a netbook computer, a personal computer (PC), a desktop computer, a personal digital assistant (PDA), a smart phone, or any programmable electronic device capable of communicating via network 230. Clients 220a,b,c are computing devices that allow their users to access services and/or information provided by server 210, in accordance with an embodiment of the present invention. Clients 220a,b,c include respective user interfaces 222a,b,c, which may each be a gesture-based, text-based, and/or graphics-based user interface. User interfaces 222a,b,c can also be, respectively, a motion tracking user interface or a combination of any of the previously mentioned user interface types. In an embodiment, user interfaces 222a,b,c are respectively each a touch screen display. User interfaces 222a,b,c can each facilitate access to services provided by server 210 (discussed below).

Server 210 is a computing device that provides content management services, in accordance with an embodiment of the present invention. Server 210 can include content management system (CMS) 214, content 216, pending content 218, rules 219, and program function 212. Content 216 is an information repository that includes content, such as audio, video, text, and/or graphics, published by CMS 214. Content 216 can also include expired content as well as rejected content. Expired content is content that is no longer available on a “live” site provided by CMS 214. Rejected content is content that has been deemed erroneous and/or outdated by one or more editors/approvers. CMS 214 is in communication with content 216 and program function 212, in accordance with an embodiment of the present invention.

CMS 214 is software that allows the publishing, editing, and modifying of content. CMS 214 can store and/or organize content in content 216 (discussed below). CMS 214 can provide version-controlled access to content included in content 216. CMS 214 can provide one or more content management services, such as publishing, format management, revision control, indexing, search, and retrieval. CMS 214 allows a user, such as the users of clients 220a,b,c to add, modify, and remove content from websites. Program function 212 is in communication with CMS 214, pending content 218, and rules 219, in accordance with an embodiment of the present invention. In certain embodiments, program function 212 includes some or all of the functions of CMS 214.

Content may benefit from publication at various review stages. For certain documents, publication may be required by a given date. For other content, it may be highly valuable to have the content available as soon as possible. In other instances, content may benefit from early publication. Other times, the accuracy or utility of content may not be ascertained until the content has been widely disseminated and reviewed. Certain aspects of the invention seek to allow content to go through one or more review steps before and/or after publication. Content is allowed to be published but still be governed by the workflow and/or business plan and may help address any possible discrepancies between timeliness and compliance. Program function 212 is software that allows content to go through one or more review steps before and after the content has been made available for viewing by the intended audience (published).

Program function 212 monitors content generation events within environment 200. Program function 212 handles content generation event according to rules included in rules 219. Program function 212 stores published content that meets predetermined criteria in pending content 218. In an embodiment, the predetermined criteria can be based on one or more of a threshold, a location, a user, a content type, and a rule. Program function 212 can, via CMS 214, publish content that meets predetermined criteria with a status of “published PENDING APPROVAL”, which denotes that the content has to undergo one or more approval steps prior to program function 212 changing the status to “published”. Information included in rules 219 can be based on one or more of analytics, likes/dislikes, elapsed time period, and user review. Rules 219 can be used to determine the final approval of content.

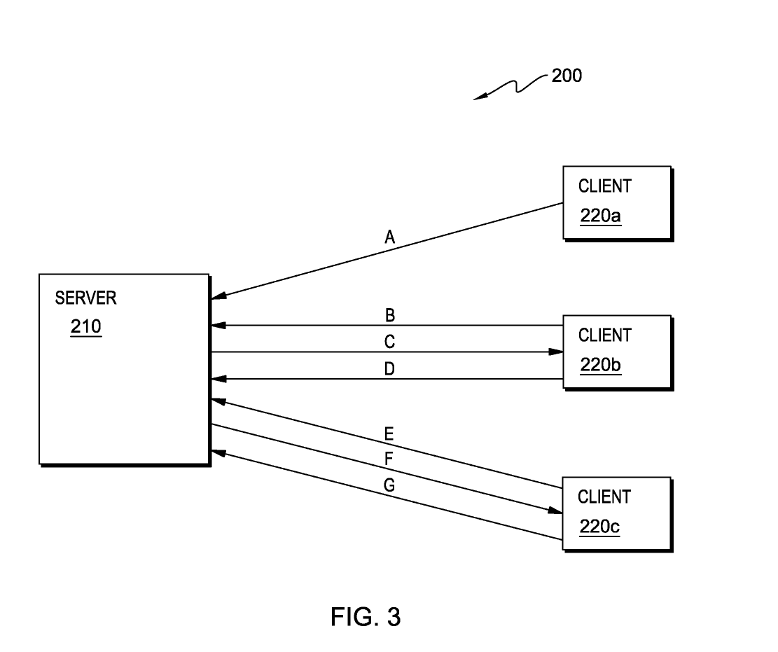

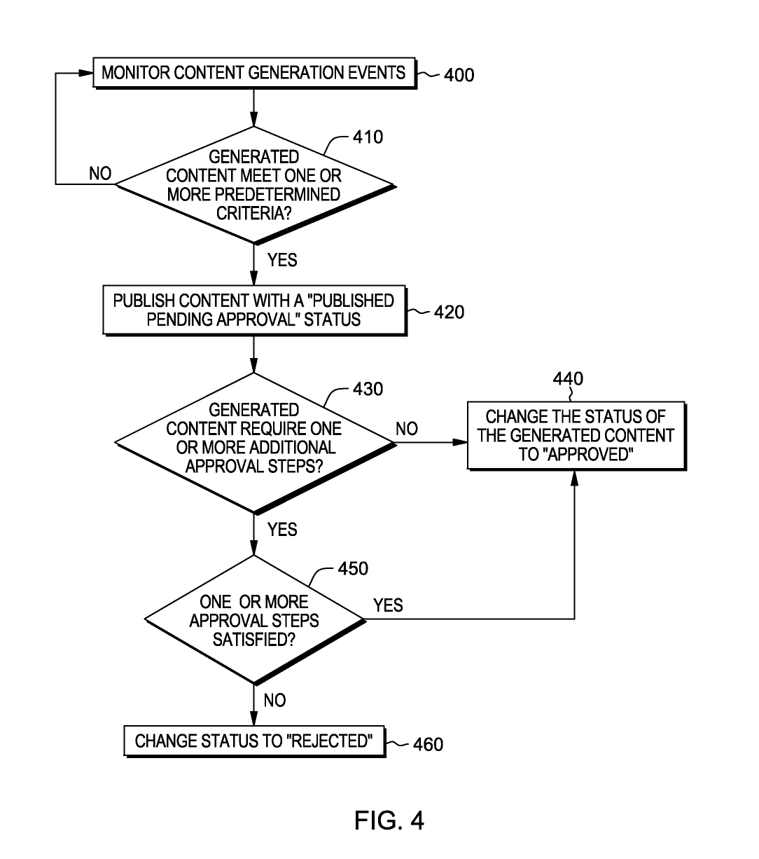

Concepts introduced in the following discussion of FIG. 3 will be used further in the discussion of FIG. 4 in the context of environment 200 of FIG. 2. FIG. 3 illustrates an embodiment of the present invention wherein content is generated and approved, in accordance with an embodiment of the present invention. Specifically, FIG. 3 is a depiction of various transmissions between the server and clients of FIG. 2. User interfaces 222a,b,care each respectively used to generate content and transmit an associated publication request (content generation event) along with the content from client 220a to server 210, via transmission A. Program function 212 accesses rules 219 and determines that the publication request includes content that satisfies a predetermined criterion, for example, the content is associated with Project XYZ.

In response to the determination, program function 212 stores the content in pending content 218 and, using CMS 214, publishes the content with a “published PENDING APPROVAL” status. The user of client 220b, User A, forwards to program function 212 a request for access to the content via transmission B. Program function 212 instructs server 210 to transmit the content to client 220b for review via transmission C. User interface 222b is used to generate the request as well as approval and/or comment on the content. For example, User A “likes” the content, which reflects their approval thereof. Client 220b transmits the approval to program function 212 via transmission D. In response to receiving User A's approval, program function 212 determines whether the status may be changed to “published” (criteria met) or “rejected” (criteria not met).

Program function 212 accesses rules 219 and ascertains that the associated rules are not satisfied. For example, to change the content's status to “published”, the associated rules included in rules 219 require both of the required reviewers to “like” the content and require a status change to “rejected”, if one or more reviewers “dislike” the content. The second required user, User B, is associated with client 220c. User interface 222c is used to generate and transmit a request for the content to server 210 via transmission E. In response to receiving the request, program function 212 accesses rules 219 and verifies that User B is a reviewer for the content. Server 210, using program function 212, transmits the content to client 220c via transmission F.

Upon reviewing the content, User B “likes” the content and transmits approval thereof to program function 212 via transmission G. Upon receipt of User B's approval, program function 212 accesses rules 219 and determines that the receipt of Users A and B approvals satisfies the criteria associated with the content and changes the status of the content to “published”.

FIG. 4 illustrates the operational steps of program function 212, in accordance with an embodiment of the present invention. Program function 212 monitors content generation events (step 400). If program function 212 determines that the content generation event does not meet one or more predetermined criteria (“no” branch decisional 410), program function 212 returns to step 400. If program function 212 determines that the content generation event meets one or more predetermined criteria (“yes” branch decisional 410), program function 212 publishes the content that is associated with the content generation event with a “published PENDING APPROVAL” status (step 420). In an embodiment, content is displayed with an ‘appended’ notification that the content “lacks officially approved”, which can be used for liability, compliance, and/or awareness purposes. In another embodiment, the published criteria may be triggered during any phase of the approval workflow.

If program function 212 determines that the generated content does not require one or more additional approval steps (“no” branch decisional 430), program function 212 changes the status of the generated content to “approved” (step 440). If program function 212 determines that the generated content requires one or more additional approval steps (“yes” branch decisional 430), program function 212 determines whether the one or more approval steps are satisfied (decisional 450). If program function 212 determines that the one or more approval steps are satisfied (“yes” branch decisional 450), program function 212 proceeds to step 440. If program function 212 determines that the one or more approval steps are not satisfied (“no” branch decisional 450), program function 212 changes the status of the generated content to “rejected” (step 460).

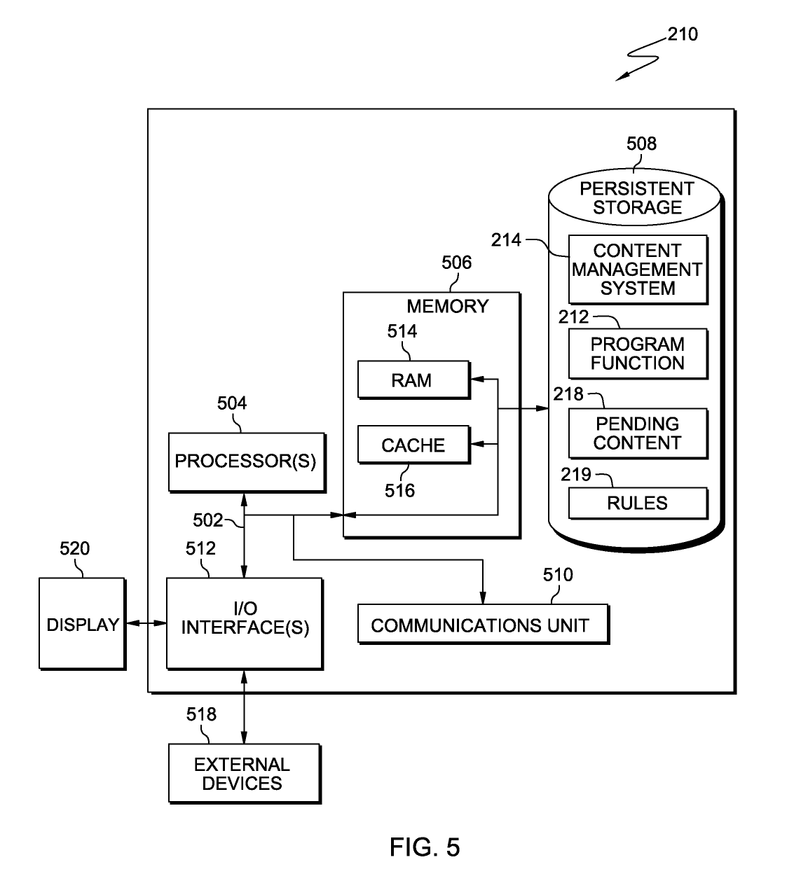

FIG. 5 depicts a block diagram of components of server 210, in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

A non-transitory computer readable storage medium embodiment herein is readable by a computerized device. The non-transitory computer readable storage medium stores instructions executable by the computerized device to perform a method that tests integrated circuit devices to measure a voltage overshoot condition.

Server 210 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer readable storage media. In this embodiment, memory 506 includes random access memory (RAM) 514 and cache memory 516. In general, memory 506 can include any suitable volatile or non-volatile computer-readable storage media.

Content management system 214, program function 212, pending content 218, and rules 219 are stored in persistent storage 508 for execution and/or access by one or more of the respective computer processor(s) 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices, including resources of clients 220a,b,c. In these examples, communications unit 510 includes one or more network interface cards. Communications unit 510 may provide communications through the use of either or both physical and wireless communications links. Program function 212 may be downloaded to persistent storage 508 through communications unit 510.

I/O interface(s) 512 allows for input and output of data with other devices that may be connected to server 210. For example, I/O interface(s) 512 may provide a connection to external device(s) 518 such as a keyboard, a keypad, a touch screen, and/or some other suitable input device. External device(s) 518 can also include portable computer-readable storage media such as, for example, thumb drives, portable optical or magnetic disks, and memory cards. Software and data used to practice embodiments of the present invention, e.g., program function 212, can be stored on such portable computer readable storage media and can be loaded onto persistent storage 508 via I/O interface(s) 512. I/O interface(s) 512 also connects to a display 520. Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus, the invention should not be limited to use solely in any specific application identified and/or implied by such nomenclature.

What is claimed is:

1. A method comprising:
receiving, by one or more computer processors, a content generation event associated with content having a status;
in response to the content generation event satisfying a predetermined criterion, publishing, by one or more computer processors, the content with a pending approval status that is associated with an approval step; and
in response to satisfaction of the approval step, changing, by one or more computer processors, the pending approval status of the content to an approved status.

2. The method of claim 1, wherein the predetermined criteria is associated with one or more of a content type, a user, a location, and a rule.

3. The method of claim 1, wherein satisfaction of the approval step includes satisfaction of a predetermined approval threshold.

4. The method of claim 1, wherein satisfaction of the approval step is at least partially based on analytics.

5. The method of claim 1, wherein satisfaction of the approval step is based on receiving one or more approvals within a predetermined time period.

6. The method of claim 1, wherein the content includes one or more of audio, video, text, and graphics.
